(19) United States
(12) Patent Application Publication
(10) Pub. No.: US 2013/0027418 A1
(43) Pub. Date: Jan. 31, 2013

(54) Image Reproduction Device Calibration

(71) Applicants: Igor Tryndin, Mountain View, CA (US); Sergey Bezryadin, San Bruno, CA (US)

(72) Inventors: Igor Tryndin, Mountain View, CA (US); Sergey Bezryadin, San Bruno, CA (US)

(21) Appl. No.: 13/191,580

(22) Filed: Jul. 27, 2011

(51) Int. Cl. G09G 5/02; G09G 5/00

(52) U.S. Cl. 345/589; 345/581

(57) ABSTRACT

Various examples within the present disclosure provide methods, apparatuses, and systems related to the calibration of image reproduction devices. Various image reproduction devices may communicate, determine calibration capabilities, and generate color profiles.

### BACKGROUND

Displays are often utilized to convey information to a user. The information may be presented differently on various displays. For example, one display may deviate in its ability to reproduce image information as intended according to an imaging standard. This deviation may be due to multiple factors including component tolerances, age, changes in temperature and humidity, and exposure to sunlight, among others. This inability to appropriately reproduce image information may lead to a degraded or unintended presentation of the information across various displays.

### BRIEF DESCRIPTION OF THE DRAWINGS

FIG. 1 illustrates a block diagram of an apparatus in accordance with an example of the present disclosure;

FIG. 2 illustrates a block diagram of a system in communication with a calibrator in accordance with an example of the present disclosure;

FIG. 3 illustrates a block diagram of a system capable of use as a calibrator in accordance with an example of the present disclosure;

FIG. 4 illustrates a block diagram of a system capable of use as a calibrator in accordance with an example of the present disclosure;

FIG. 5 illustrates an example apparatus in use to calibrate an image reproduction device in accordance with the present disclosure;

FIG. 6 illustrates an example of an image reproduction device being calibrated in accordance with the present disclosure; and

FIGS. 7-10 illustrate examples of flow diagrams in accordance with the present disclosure.

### DETAILED DESCRIPTION

Displays such as cathode ray tubes (CRTs), liquid crystal displays (LCDs), light emitting diode (LED) displays, and projectors, among others, are generally utilized to convey visual information to a user. The information may include images, text, or other data intended for display in a manner consistent with its creation. For example, an image may have been generated or modified using a first computing device. The first computing device may have a display that has been calibrated to output the image in a certain manner or according to a desired standard, such as D65 white point standard. When the image is then transferred to a second computing device for viewing, alteration, or another action, a difference in a display of the second computer, which may not have been calibrated, may present the image in an unintended and/or degraded manner.

While calibrating devices may ensure proper output of data across multiple devices, or at least mitigate unintended changes, calibration is not always feasible. Calibration equipment generally utilizes specific ports not available on all devices, for example mobile devices. Additionally, the equipment is implemented through specific hardware that may not be available on all devices, and is generally too cumbersome to utilize on a frequent and mobile basis.

In the present disclosure, apparatuses, systems, methods, and corresponding programming are disclosed that enable an image reproduction device to control initiation and calibration via a wireless communication channel, to determine a calibration capability of a calibrator, thus enabling calibration via multiple and distinct calibrators, and to calibrate other image reproduction devices. For example, a computing device may be wirelessly calibrated by a calibrator, but may also calibrate other devices, irrespective of its own calibration.

Image reproduction devices, as used herein, are defined as computing devices capable of reproduction, production, and output of images. Example image reproduction devices include desktop computers, notebook computers, netbooks, slates, tablets, smart phones, mobile phones, projectors, television screens, displays, and printers, among others. The image reproduction devices may reproduce and/or produce images before and/or after calibration events.

A calibration event is defined as an event in which the image reproduction device is analyzed based on its presentation of data, or alternatively, analyzes another device based on that device's presentation of data. The calibration event may result in the generation of a color profile. A color profile is defined as a profile where image reproduction device characteristics are stored that enable reproduction and production of image information as intended by its image-encoding standard. The color profile may be an International Color Consortium (ICC) profile, but other profiles and settings are contemplated. The color profile may control and/or describe the presentation of color and black and white images. In others words, any reference to color herein should be understood to include color, black and white, and any grayscale in between.

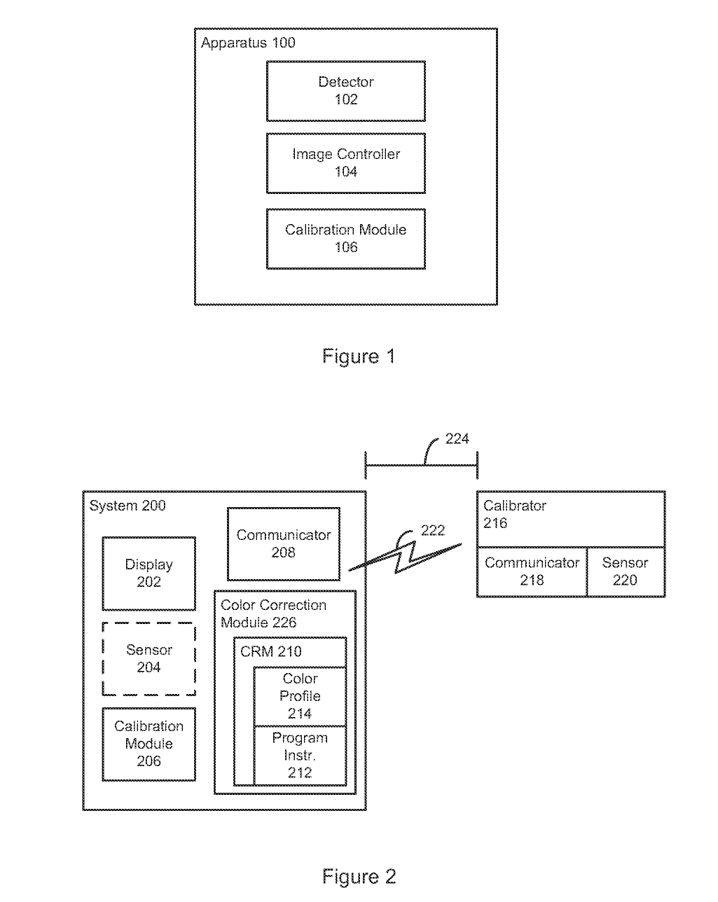

Referring to FIG. 1, an apparatus is illustrated in accordance with the present disclosure. As illustrated, the apparatus 100 includes a detector 102, an image controller 104, and a calibration module 104. While illustrated as distinct components, one or more of the components may be combined. Additionally, other components may be included without deviating from the scope of the disclosure. Apparatus 100 may be embodied as an application specific integrated circuit (ASIC) or a collection of hardware and software components. The apparatus 100 may be integrated into various devices, such as an image reproduction device, and may interface with various components of the image reproduction device including displays, communicators, processors, controllers, sensors, camera, and other devices.

Apparatus 100, in various embodiments, enables an image reproduction device to calibrate an output device, such as a display. In one example, an image reproduction device incorporating apparatus 100 may calibrate a local output device, for example, the image reproduction device may calibrate its own display with help of a calibrator. In another example, the image reproduction device may utilize a local sensor, for example a camera, to calibrate another image reproduction device. To perform a calibration event, the apparatus utilizes the detector 102, the image controller 104, and the calibration module 106.

The detector 102 of apparatus 100 is to determine a calibration capability of a calibrator. A calibrator is a device that analyzes an output of an image reproduction device. Calibrators may have varying sensitivities and capabilities. For example, a calibrator's precision with respect to luminance measurements, chromaticity measurements, and gamut bounds, among others, may vary from one calibrator to another. Detecting these calibration capabilities and sensitivity, via detector 102, may enable the image reproduction device incorporating apparatus 100, to more accurately calibrate its output by altering a calibration image to accommodate the varying capabilities of various calibrators.

The alteration or control of the calibration image is accomplished by the image controller 104, which is coupled to the detector 102. The image controller 104 may control display of a calibration image based on the determined calibration capability of the calibrator. A calibration image is defined as an image having characteristics or properties that enable the image reproduction device to be calibrated. The image controller may control display of the calibration image by selecting and/or altering the calibration image appropriate for the calibrator.

In addition to selecting and/or altering the calibration image based on the detected calibration capabilities of the calibrator, the image controller 104 may control display of the calibration image on a local display. For example, an image reproduction device may calibrate its output device (e.g., a display) with a calibrator. To accomplish this, the image controller 104 may control display of the calibration image on the local display.

In another example, which will be discussed in more detail herein, an image reproduction device incorporating apparatus 100 may be utilized to calibrate a second image reproduction device. In this example, the image controller 104 may control display of a calibration image on the second image reproduction device. In various examples, this may involve the transmission of the calibration image from the image reproduction device to the second image reproduction device.

The calibration module 106 is coupled to the image controller 104 and is to generate a color profile based on calibration data received in response to display of the calibration image. In one example, the calibration module 106 may generate an International Color Consortium (ICC) profile based on the calibration data. Calibration data is defined as any data related to the analysis of a calibration image. Calibration module 106 may include a combination of hardware and software.

In one example, the image controller 104 may control display of an image on a local display (e.g., a display of the image reproduction device incorporating the apparatus 100), and the calibration module may generate a color profile for the local display. In another example, the image controller 104 may control display of an image on the display of another image reproduction device, and the calibration module 106 may generate the color profile for the other image reproduction device in response to receipt of the image calibration data. To receive the calibration data, which is based on the image displayed on the other image reproduction device (e.g., the remote device), the calibration module 106 may control a sensor to receive the calibration image. The sensor, in one example, may be a camera. In this manner, the apparatus 100 may be utilized in manner that enables an image reproduction device to calibrate itself, as well as other image reproduction devices. The various scenarios will be discussed in more detail with respect to the following figures.

Referring to FIGS. 2-4, various examples of image reproduction devices are illustrated. As illustrated, the image reproduction devices include components with solid and dashed lines. The dashed lines are indicative of components which are not utilized in the illustrated scenario, but may still be present within the system. Other components may also be included without deviating from the scope of the disclosure.

With reference to FIG. 2-4, the systems comprise a display, a sensor, a calibration module, a communicator, and a color correction module that includes computer readable medium. The computer readable mediums are capable of storing a color profile and programming instructions. The systems are examples of image reproduction devices. As stated previously, image reproduction devices may be computing devices such as, but not limited to, a smart phone, a tablet computer, a slate computer, a cell phone, a mobile device, or a printer.

As illustrated, the displays are components to output visual information. The displays may be cathode ray tubes (CRTs), liquid crystal displays (LCD), a light emitting diode (LED) displays, projection elements that project an image on to, for example, a screen, or any other component capable of conveying visual information. The displays are to display a calibration image to enable a calibrator, such as calibrator 216 to receive a calibration image and provide feedback.

Sensors are coupled to the displays and are capable of receiving information from other devices. The sensors illustrated in the figures may be camera sensors capable of receiving information related to ambient light, color, hue, contrast, brightness, and may be configured to convey this received information to the calibration module. While one sensor is illustrated in each system, more or fewer sensors may be utilized without deviating from the scope of the disclosure. In one example, a sensor is a camera suitable for capturing images, and is to capture a calibration image on another display and provide the calibration image or associated data, to the calibration module to enable the calibration module to generate the color profile.

Calibration modules, in the examples, are components encompassing the functionality of apparatus 100 of FIG. 1. That is, calibration modules are to detect calibration capabilities, control displays to display calibration images, and generate color profiles. In the illustrated examples, calibration modules output a calibration image via a display to generate a system color profile. In addition, the calibration modules are to control the sensor to receive or capture another calibration image to generate a color profile for a different image reproduction device.

A communicator as illustrated in FIGS. 2-4 is defined as a component capable of communication with another device. The communicators may include hardware, software, or a combination of the two. The communicators may communicate with various devices, for example a calibrator or another image reproduction device, using various wireless protocols such as, but not limited to near-field communication (NFC), wireless local area networks, Bluetooth technology, or infrared communication. Other protocols and manners of transmitting data are contemplated. The wireless communication link may ensure that various devices having limited input and output ports, for example a mobile phone, may have their displays calibrated in accordance with a desired imaging standard.

The color correction modules are coupled to the various components and comprise a computer readable medium, a color profile, assuming one has been generated, and programming instructions which are executable by a processor to enable the various systems to perform operations as described herein. The color correction modules are to adjust a setting of the display based on the system color profile. That is, the color correction modules are to affect the displays based on the calibration.

While the color correction modules are illustrated as part of the systems, it should be understood that the color correction modules may be implemented in a display that is distinct from the image reproduction device. For example, various displays (and printers) support a capability of in-device loading of color profiles. These displays perform corrections in the display circuitry, as opposed to, for example, a video adapter card. Correction within the display may enable a more accurate transformation, such as an 8 bit to 12 bit transform of the image signal. In video adapters, transforms are often 8 bit to 8 bit.

With reference now to the individual Figures, various scenarios will be described in more detail. Referring to FIG. 2, an illustration of a system 200 being calibrated by a calibrator 216 is illustrated. Calibrator 216 is a device capable of calibrating a display; it includes a communicator 218 and a sensor 220.

In the illustrated example, calibrator 216 is brought within a communication distance 224 of system 200. System 200 via communicator 208 is able to detect calibrator 216 and initiate a calibration event. The detection of calibration 216 may be done via near field communication (NFC). Near field communication may occur when two communicators 208, 218 are brought within a predetermined distance of each other, for example within approximately two tenths of a meter. The two communicators 208, 218 may communicate and establish a communication link 222. Based on the communication link 222, the system 200 and calibrator 216 may perform the calibration event, or alternatively, the communication link 222 may be utilized to initiate the calibration event and other manners of communication, e.g., Bluetooth or a wireless local area network may be utilized to transfer any calibration data.

After detecting the calibrator 216, system 200, via calibration module 206, may determine a calibration capability of the calibrator 216. For example, the calibration module 206 may determine an accuracy or sensitivity of sensor 220 of the calibrator 216. In one example, after detection of calibrator 216, the calibrator 216 via communicator 218, communicates its precision on luminance measurements and its precision on color or chromaticity measurements. The precision may be communicated as a percentage of relative error. In other examples, other characteristics of the calibrator 216 may be communicated, and characteristics of the system may be communicated to the calibrator, for example the bounds of the system's gamut, which may include the volume of color stimulus the system is capable of reproducing.

After a determination of the calibration capability of the calibrator 216, the calibration module 206 may display a calibration image via the display 202. The calibration image may have been selected or configured based upon the determined capability of the calibrator 216.

Once displayed, the calibrator 216, via sensor 220, may receive or capture the image. The calibrator 216 may then communicate the calibration data, which is based on the captured calibration image, to the system 200 via communicators 218 and 208. Once received by the system 200, the calibration module 206 may calibrate the display 202 by generating a color profile. The color profile may be stored in the computer readable medium (CRM) 210 of color correction module 226. Once stored, the color correction module 226 may implement the color profile 214 such that the display 202 is affected to display an image in accordance with the image's intended standard.

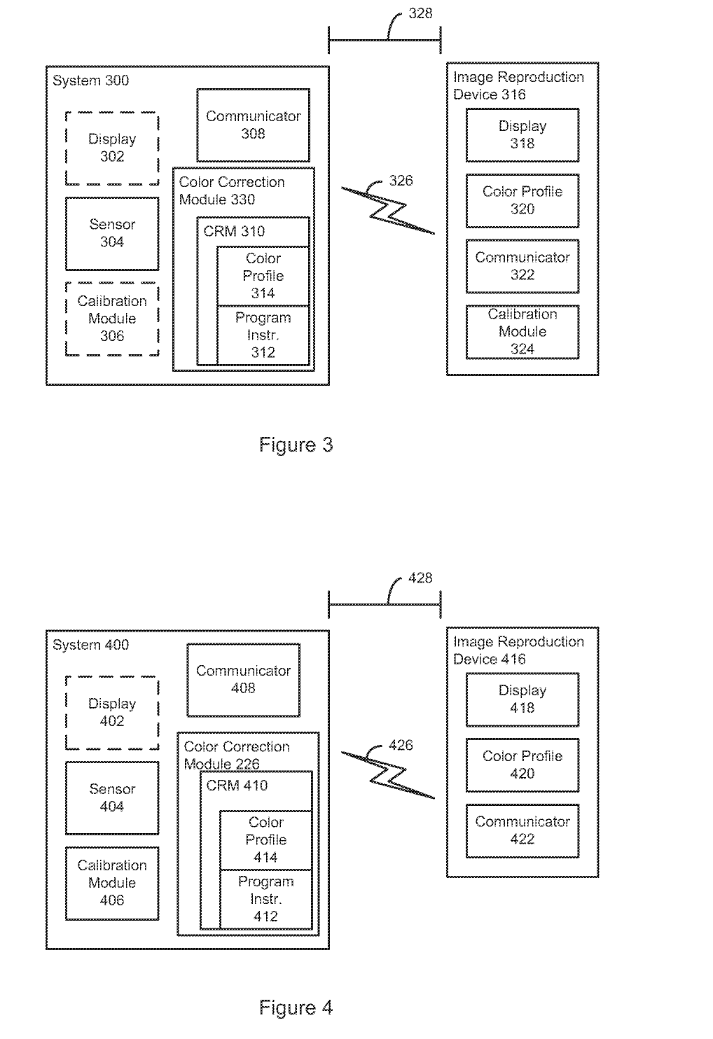

Referring to FIG. 3, an illustration of a system 300 providing calibration feedback to an image reproduction device 316 is illustrated. In the Figure, system 300 is to calibrate display 318 of image reproduction device 316.

Similar to FIG. 2, the calibration event may be based on detection of a calibrator within communication distance 328. In the illustrated figure, the calibrator is system 300, which may be a system similar to system 200 of FIG. 2. Instead of detecting a calibrator as in FIG. 2, communicator 308 may detect image reproduction device 316 via communicator 322. Alternatively, image reproduction device 316 may detect system 300. Based upon the detection, a wireless link 326 may be established.

Via wireless link 326, image reproduction device 316 may determine a calibration capability of system 300. The calibration capability of system 300 may be based on one or more characteristics of sensor 304, for example system 300's precision on luminance measurements and its precision on color or chromaticity measurements. Based on this information, image reproduction device, via its calibration module 324, may display a calibration image on display 318. The calibration image may be tailored to the capabilities of the sensor 304.

With the image reproduction device outputting the calibration image, the sensor 304 of system 300 may capture or receive the calibration image. Once received, the communicator may communicate the calibration image or calibration data associated with the image back to the image reproduction device 316 to enable the image reproduction device, via calibration module 324, to generate a color profile 320. The color profile 320 may then be used to affect the display 318.

In this manner, system 300 may be utilized as a calibrator for another image reproduction device. The system may utilize a sensor, for example a camera, to analyze a calibration image tailored to the cameras capabilities. This may enable the image reproduction device 316 to calibrate display 318 in an efficient manner.

Referring to FIG. 4, an example is illustrated wherein system 400 is utilized to calibrate image reproduction device 416. In this example, image reproduction device 416 may not include any functionality or components that enable the image reproduction device 416 to calibrate its display 418. Consequently, system 400 may analyze a calibration image output by the image reproduction device 418, generate an appropriate color profile, and transmit the color profile.

In the Figure, the calibration event may be based on detection of a calibrator within communication distance 428. In the illustrated Figure, the calibrator is system 400, which may be a system similar to system 200 or 300 of FIGS. 2 and 3. Instead of detecting a calibrator as in FIG. 2, communicator 408 may detect image reproduction device 416 having communicator 422. Detection may occur when two NFC devices are brought within a communication distance, for example a distance of less than 0.2 meters. This may enable communicator 408 and communicator 422 to establish a wireless link 426.

After establishment of link 426, system 400 may begin a calibration event. The calibration module 406, in this example, does not need to detect any calibrator capabilities as the sensor and its characteristics are local to the system 400. Consequently, the system 400, via calibration module 406 may control display 418 of image reproduction device 416 to display a calibration image. The calibration image may be transferred to the image reproduction device 416 via communication link 426, or alternatively, the calibration module 406 may control the image reproduction device 416 to display a calibration image local to image reproduction device 416.

Once the display 418 of image reproduction device 416 has output the calibration image, the sensor 404 may be controlled to capture or receive the calibration image. The calibration image may be provided to the calibration module 406 which may then generate a color profile 420 for the image reproduction device 416. The color profile 420, once generated may be communicated to the image reproduction device 416 via communication link 426.

While display 402 of system 400 is illustrated dashed lines, thus indicating that it is unnecessary for the illustrated example, it should be understood that display 402 may also display a user interface which may be utilized to control the calibration event. For example, the display 402, rather than an NFC detection, may be utilized to initiate the calibration event, select one or more characteristics, or perform other operations associated with the calibration event.

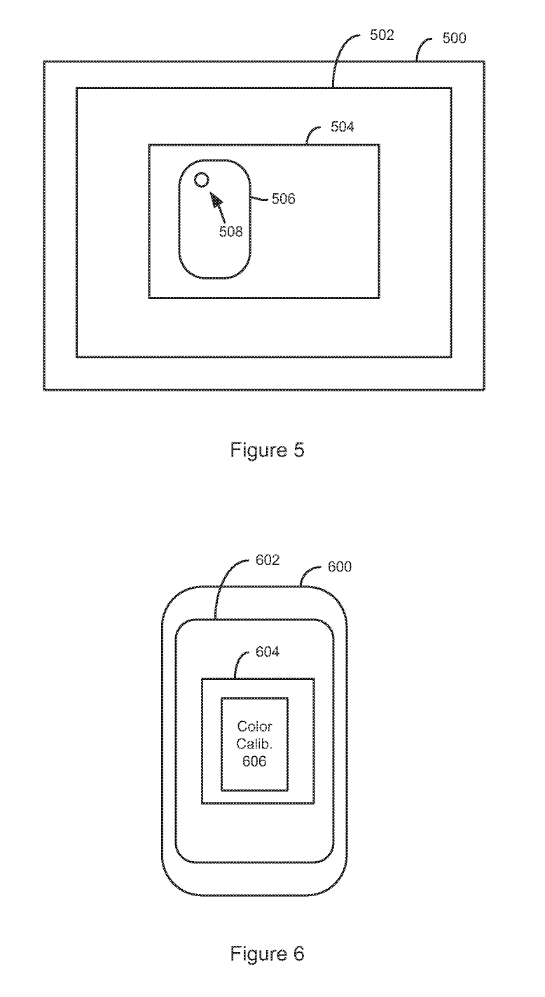

Referring to FIG. 5, an apparatus 506 in use to calibrate an image reproduction device 500 is illustrated. In the Figure, system 506 may be a system as described with reference to FIGS. 2-4. System 506 includes a camera 508. Image reproduction device 500 may be also be a device as discussed with reference to FIGS. 2-4, or alternatively, may be a computing device not having the functionality associated with the prior figures.

Image reproduction device 500 includes a display area 502. Image reproduction device 500 may be a slate device, a tablet device, a television, or any other device incorporating a display. To calibrate display 502, system 506 may be brought within a communication distance to the image reproduction device 500. As illustrated, the system 506 may be placed in contact with the display 502 of image reproduction device 500.

Based on the proximity, the system 506 may establish a wireless communication link with the image reproduction device 500. The system 506, via the wireless communication link, may control the image reproduction device 500 to display an image 504. In one example, the system 506 may transfer the image to be displayed to the image reproduction device 500. In another embodiment, the system 506 may merely control the system 500 to display an image stored in memory of the image reproduction device 500. The image 504 may be a calibration image.

With the image 504 displayed, the system 506 may receive the calibration image via a camera sensor. Alternatively, the system 506 may receive the calibration image via another sensor other than a camera sensor. Based on the received calibration image, the system 506 may generate a color profile for the image reproduction device. The color profile may be an ICC profile. In another example, the system 506 may generate calibration feedback, which enables the image reproduction device 500 to generate the color profile.

Based on the color profile, the image reproduction device 500 may display an image without degradation of the aesthetic characteristics of the image. For example, the image reproduction device 500 may now be utilized to display an image generated on a calibrated computing device, the image being displayed as intended.

Referring to FIG. 6, an example scenario of a calibrator 606 in use to calibrate a system 600 is illustrated. In the example, system 600 may be a computing device as described with reference to FIGS. 2-4. The system may include a display 602 capable of displaying an image 604. Image 604 may be a calibration image. Calibrator 606 may be a calibration device as described with reference to calibrator 216 of FIG. 2, or alternatively may be a system as described with references to FIGS. 2-4.

In the Figure, calibrator 606 is brought within a communication distance to system 600. The system 600 may detect the calibrator 606 and establish a wireless communication link. Via the wireless communication link, the system 600 may determine a calibration capability of the calibrator. Based on the determined calibration capabilities, the system 600 may additionally set one or more parameters for the calibrator 606 or the calibration procedure.

With the calibration capabilities determined, the system 600 may display an image 604 on display 602. The image may be a calibration image having properties known to the calibrator 606. Based on the properties, the calibrator 606 may generate calibration feedback to enable the system 600 to calibrate the computing device. The calibration may include the generating of an ICC profile by the system 600. Based on the color profile (e.g. the ICC profile) the display 602 may display an image in a manner similar to another calibrated computing device.

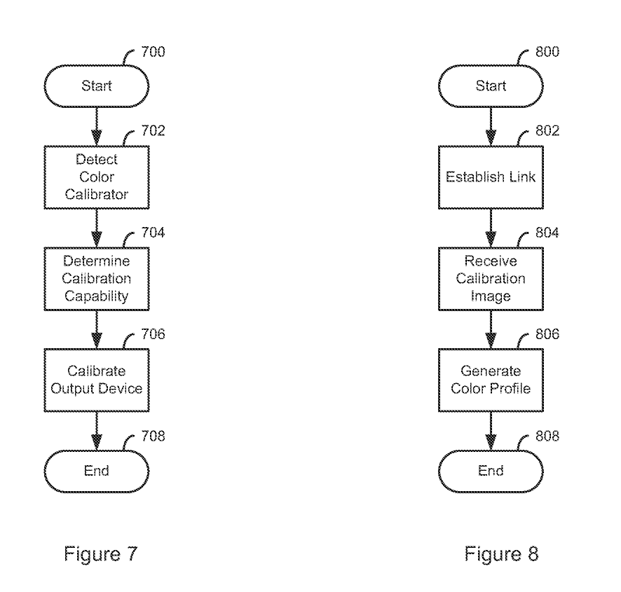

Referring to FIGS. 7-10, flow diagrams describing methods associated with a system as described in FIGS. 1-6 are illustrated. While discussed in a particular order with reference to the Figures, the disclosure is not intended to be limited to any particular order.

In FIG. 7, the method begins at 700 and progresses to 702 where the system may detect a calibrator. Detection may be based on near field communication (NFC), for example via a wireless communication link, user interaction with one or both devices, or other means. With the wireless communication link established, the system may determine a calibration capability of the calibrator via wireless communication link at 704.

Determining a calibration capability of the color calibration may include setting one or more parameters based on the determined capabilities. For example, if a sensor or filter having a characteristic is determined, a white point or target luminance may be altered accordingly.

Based on the determined calibration capabilities, the system may calibrate the display of the system at 706. Calibration may include generation of a color profile, for example an ICC profile. Alternatively, a calibration event may determine a display to be within an acceptable range and forgo generation of a color profile. Once calibration is complete, the method may end at 708.

In FIG. 8, a method of calibrating an image reproduction device with a system as discussed in reference to FIGS. 2-4 is illustrated. The method may begin at 800 and progress to 802 where the system may establish a wireless communication link with the image reproduction device. Establishment of the wireless communication link may be based on near field communication or other protocols.

With the wireless communication link established, the system may receive a calibration image at 804. Receipt of a calibration image may result from controller the image reproduction device to display the image. The control of the image reproduction device may comprise transfer of the calibration image from the system to the image reproduction device, or alternatively, display of a calibration image stored in memory of the image reproduction device.

Upon receipt of the calibration image, the system may generate a color profile for the image reproduction device at 806. The color profile may enable the image reproduction device to display an image in accordance with an imaging standard, or alternatively, may enable the image reproduction device to display an image in accordance with parameters generated on a reference computing device. The method may then end at 808.

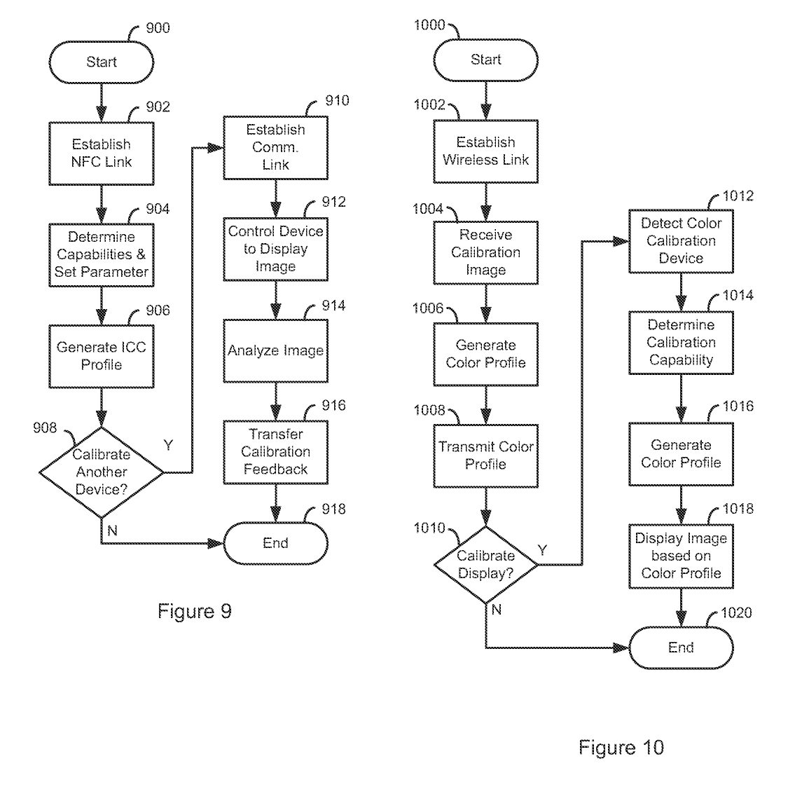

Referring to FIG. 9, another method is illustrated in accordance with the present disclosure. The method may begin at 900 and progress to 902 where the system may establish an NFC link with a calibrator. Upon establishment of the NFC link, the system may set a parameter for calibration at 904. Setting the parameter may be in response to a determination of calibration capabilities. With various parameters set and calibration capabilities determined, the system may generate an ICC profile at 906.

Once calibrated, the system may continually determine whether another image reproduction device is in need of calibration at 908. If not, the method may end at 918. Alternatively, if an image reproduction device is detected at 908, the method may continue to 910 where the system may establish a wireless communication link with the image reproduction device. The wireless communication link may be a NFC communication link or another type of wireless communication link.

After the wireless communication link is established, the system may control the image reproduction device to output an image at 912. The image may be a calibration image that is either transmitted to the image reproduction device via the established communication link, or alternatively, be a calibration image retrieved from the memory of the image reproduction device.

Once displayed by the image reproduction device, the system may analyze the calibration image at 914. The analysis may result in generation of calibration feedback which may ultimately be transferred back to the image reproduction device at 916. Upon transfer of the calibration feedback at 916, the method may end at 918.

Referring to FIG. 10, another method is illustrated in accordance with the present disclosure. The method begins at 1000 and progresses to 1002 where the system may establish a wireless communication link with an image reproduction device. The wireless communication link may be a NFC link or another type of wireless connection.

At 1004, the system may receive a calibration image from the image reproduction device. That is, the image reproduction device may display an image, for example a calibration image that was either transmitted to the image reproduction device via the established wireless communication link, or present in the memory of the image reproduction device. Once displayed, the system may receive the image via a sensor, such as a camera sensor.

Upon receipt of the image from the image reproduction device, the system may generate a color profile for the image reproduction device at 1006. The color profile may be an ICC profile, or may be a profile having characteristics determined by a user. The system may then transmit the color profile to the image reproduction device to enable the image reproduction device to output other images in a desired manner at 1008.

Before or after the calibration of the image reproduction device, the system may determine whether or not to calibrate its display. At 1010, the system may determine whether to calibrate a display associated with the system. If a determination is made not to calibrate at 1010, the method may end at 1022. Alternatively, a decision is made to calibrate at 1010 the method may progress to 1012, where the system may detect a calibrator. In various examples, detection of the calibrator at 1012 may serve as the determining factor on whether or not to calibrate the system.

Once detected, the system may determine a calibration capability of the calibrator at 1014. Based on the calibrator capabilities, the system may determine a desired luminance and white point. Other settings, parameters, and characteristics may be set. In response, the determination of the calibration capabilities and the determined white point and luminance, the system may generate a color profile at 1016. The color profile may be an ICC profile, or a color profile having characteristics determined by a user, After generation of the color profile, the system may implement the color profile and display an image based on the color profile at 1018. The method may then end at 1022.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope of this disclosure. Those with skill in the art will readily appreciate that embodiments may be implemented in a wide variety of ways. This application is intended to cover any adaptations or variations of the embodiments discussed herein. Therefore, it is manifestly intended that embodiments be limited only by the claims and the equivalents thereof.

What is claimed is:

1. A method, comprising:
detecting, by an image reproduction device, a calibrator via a wireless communication link;
determining, by the image reproduction device, a calibration capability of the calibrator via the wireless communication link; and
calibrating, by the image reproduction device, an output device of the image reproduction device based on the determined calibration capability of the calibrator.

2. The method of claim 1, wherein calibrating the output device of the image reproduction device comprises generating an International Color Consortium (ICC) profile.

3. The method of claim 1, wherein calibrating the output device comprises displaying a calibration image via a display, and receiving calibration feedback from the calibrator in response to the displaying.

4. The method of claim 1, wherein calibrating the output device comprises displaying a calibration image via a display, and receiving a color profile from the calibrator in response to the displaying.

5. The method of claim 1, further comprising:
establishing, by the image reproduction device, a communication link with a second image reproduction device;
controlling, by the image reproduction device, the second image reproduction device to display an image; and
transferring, by the image reproduction device, calibration feedback to the second image reproduction device based on the image.

6. The method of claim 1, further comprising:
establishing, by the image reproduction device, a communication link with a second image reproduction device;
controlling, by the image reproduction device, the second image reproduction device to display an image; and
transferring, by the image reproduction device, a color profile to the second image reproduction device based on the image.

7. The method of claim 6, further comprising:
analyzing, by the image reproduction device, the image via a camera of the image reproduction device; and
generating, by the image reproduction device, the color profile for the second image reproduction device based on the analyzing.

8. An apparatus, comprising:
a detector to determine a calibration capability of a calibrator;
an image controller, coupled to the detector, wherein the image controller is to control display of a calibration image based on the determined calibration capability of the calibrator; and
a calibration module coupled to the image controller, wherein the calibration module is to generate a color profile based on calibration data received in response to display of the calibration image.

9. The apparatus of claim 8, wherein the image controller is to control display of the calibration image on a local display; and
wherein the calibration module is to generate the color profile for the local display based on the calibration data.

10. The apparatus of claim 8, wherein the image controller is to control display of the calibration image on an image reproduction device; and
wherein the calibration module is to generate the color profile for the image reproduction device based on the calibration data.

11. The apparatus of claim 8, wherein the detector is to determine a spectral sensitivity of the calibrator.

12. The apparatus of claim 8, wherein the calibration module is to generate an International Color Consortium (ICC) profile.

13. The apparatus of claim 8, wherein the image controller is further to control a sensor to receive another calibration image and generate calibration data in response to receipt of the another calibration image.

14. A system, comprising:
a display;
a sensor coupled to the display; and
a calibration module coupled to the display and the sensor, wherein the calibration module is to output a calibration image via the display to generate a system color profile and control the sensor to receive another calibration image to generate a color profile for an image reproduction device.

15. The system of claim 14, wherein the sensor is a camera.

16. The system of claim 14, further comprising:
a communicator coupled to the calibration module, wherein the communicator is to establish a communication link with a calibrator and receive calibration data in response to output of the calibration image via the display.

17. The system of claim 16, wherein the calibration module is further to determine a calibration capability of the calibrator.

18. The system of claim 14, further comprising:
a communicator coupled to the calibration module, wherein the communicator is transmit the color profile to the image reproduction device.

19. The system of claim 14, wherein the calibration module is further to control display of the another calibration image on the image reproduction device.

20. The system of clam 14, further comprising:
a color correction module coupled to the calibration module, wherein the color correction module is to adjust a setting of the display based on the system color profile.
